(19) United States
(12) Patent Application Publication
(10) Pub. No.: US 2015/0287075 A1
(43) Pub. Date: Oct. 8, 2015

(54) SYSTEM AND METHOD OF MARKETING BEAUTY PRODUCTS

(71) Applicant: Yawlin C. Chen, Los Angeles, CA (US)

(72) Inventor: Yawlin C. Chen, Los Angeles, CA (US)

(21) Appl. No.: 14/743,938

(22) Filed: Jun. 18, 2015

Related U.S. Application Data
(63) Continuation of application No. 13/813,155, filed on Mar. 21, 2013, now abandoned.
Application No. 13/813,155 is a continuation-in-part of application No. 12/370,425, filed on Feb. 12, 2009.
(60) Provisional application No. 61/087,882, filed on Aug. 11, 2008.
(60) Provisional application No. 61/040,113, filed on Mar. 27, 2008.
(60) Provisional application No. 61/028,494, filed on Feb. 13, 2008.

(51) Int. Cl. G06Q 30/02

(52) U.S. Cl. CPC G06Q 30/0251

(57) ABSTRACT

The present invention relates to a system and method of marketing beauty products, and more particularly to a system and method of marketing beauty products to male customers in a male-frequented setting. In one embodiment, the method includes obtaining a display having advertising space for beauty products, locating the display in a male-frequented venue, and providing information about and access to the beauty products at the display. The display may be, for example, a freestanding kiosk. The male-frequented venue may be an automotive store, such as an automotive parts store or service center, or a non-automotive store or venue, such as an electronics or home improvement store or sports arena. The beauty products can be configured to include one or more characteristics of the male-frequented venue, such as an automotive theme at an automotive venue, such that the beauty products blend in with the surrounding environment. The method provides a cost-effective, economical, convenient, comfortable, reliable, and private way to advertise and provide access to beauty products directly to target consumers without the disadvantages related to marketing through traditional advertising and retail channels.

### FIELD OF THE INVENTION

The present invention relates to a system and method for marketing beauty products, and more particularly to a system and method for marketing beauty products to male customers at a male-frequented venue.

### BACKGROUND

Male customers can find it difficult, both psychologically and practically, to buy beauty and skin care products in a comfortable environment. “Beauty products” as used herein may include skin care products, anti-aging products, hair care products, fragrances, and other similar cosmetic and grooming items targeted to males. There are several reasons why male customers have difficulty buying beauty products, and why beauty suppliers have difficulty targeting these customers.

First, male customers often need to be properly educated about the products in order to make an informed purchasing decision. There are many male-oriented beauty products on the market from which the male customer can choose. The male customer may not be familiar with these products and may not feel comfortable asking friends or family for product recommendations. Accordingly, the customer often needs to be educated properly at the point of sale.

The human skin is the largest organ of the human body. It serves a variety of functions, including helping to protect the body from germs and infections, and regulating body temperature and secretion. Like routine exercise and a balanced diet, proper skincare is an important part of a healthy life style for both men and women. Although the beauty industry, as experts in skincare, grooming and anti-aging products, should be in the best position to educate and persuade male consumers about the need for proper skincare as part of a healthy lifestyle, traditional marketing efforts by the beauty industry to reach male consumers with this message have been ineffective. In fact, these marketing efforts are sometimes even counter-productive, sending the message that skincare is intended only for women. Traditional advertising campaigns, product promotions, and attempts at superficial brand recognition fail to take into account the psychology and shopping habits of male consumers and fail to provide the substantive education that is the crucial first step in laying the foundation for male consumers to embrace a beauty routine as a part of a healthy lifestyle.

Second, the locations where male customers have access to beauty products each have their disadvantages. Drug and grocery stores have limited selections and often stock lower quality products. These stores also do not offer a sales clerk to answer questions about the products. Upscale department stores may carry a wider selection and employ a sales clerk, but customers often feel awkward and pressured to buy something. Customers typically have to interact with a sales clerk to make a purchase, which may make them feel less private and more pressured to make a purchase or leave the store. Additionally, the sales clerks are often familiar with only one or a few selected brands. Beauty salons and spas have very knowledgeable beauty consultants, but these spas are often expensive and do not cater to a wide male audience. Also, male customers may not feel comfortable frequenting these spas and salons. Finally, websites and television infomercials allow customers to browse with no sales pressure, but they do not give the customer a chance to inspect the product or ask any questions, and returns can be difficult. Customers may also find it difficult to assess the credibility or quality of a product sold on the television or Internet. Thus, many male customers do not have a sustainable routine for shopping for beauty products.

Third, many beauty products do not offer enough information on their packaging for the male customer to make a decision. Some packaging includes a phone number to reach the brand manufacturer, but this is often a main corporate number and not a dedicated help line. These companies are also closed during many of the hours that male customers generally shop. The beauty product packages and labels often follow a familiar layout and design that identifies the product as part of a beauty product line and that fails to attract the attention of the male customer. As a result, the male customer does not approach the product and therefore does not learn about the product and the benefits of a daily skincare routine.

Fourth, large beauty companies find it difficult to market beauty products to male customers in a way that the male customers will actually find appealing and inviting. The male customer often needs to be educated about the variety and proper use of these products. Equally importantly, the male customer needs a comfortable and private environment from which to make informed purchases. Currently, many of the larger beauty suppliers devote the bulk of their marketing budget to women. Many of the smaller beauty suppliers have difficulty competing with the advertising budgets of the larger companies and are unable to effectively market to either gender, let alone invest in educating the male customer, in addition to providing comfortable and private retail locations where male customers can shop.

Thus, existing practices, methods, and systems utilized by the beauty industry to market male beauty products are fundamentally flawed and fail to take into account important differences in preferences between male and female consumers. The traditional beauty venue with its dizzying array of products and its doting sales clerks and beauty consultants can be very uncomfortable for the male customer. As a result, men rarely shop for beauty products at these traditional retail beauty venues, making it difficult for the beauty industry to educate and convince men of the need for and proper use of beauty products. Efforts by the beauty industry to market men's products have been limited to marketing to female consumers to purchase products for men, or to ineffective marketing campaigns directed at male consumers that fail to address the many problems identified above.

At the same time that the beauty industry is dealing with these problems, the retail automotive industry is facing new challenges of its own. As the automotive and automotive service industries get increasingly competitive, these businesses are constantly on the look-out for products to diversify their services and increase revenue. For example, quick oil change stores often look for new maintenance services such as transmission fluid exchanges, fuel injection cleaning and radiator flushes, etc., and add-on products such as windshield crack repairs, dent repairs, bottle cleaners/additives, windshield wipers, windshield glass treatments, fuel line magnets and filters, etc. to sell to the car owner in order to increase the service ticket, even though the car owner's initial intent could be just a simple oil change. Some automotive service suppliers have expanded their services by offering automotive and land travel-related accessory products for sale, such as sunglasses, air fresheners, GPS devices, satellite radios, etc. However, in the past, these extra products have been limited to services and items related to automotive/car or travel. Additionally, customers can easily and comfortably shop for these non-service related items elsewhere. Thus, automotive and automotive service industry suppliers, including the wholesale, retail, equipment, parts, and services suppliers, can benefit from new ideas and products to diversify their services, give them a competitive edge, and increase their revenue.

This need to obtain a competitive edge is not limited to the automotive industry, of course, and many other male-frequented businesses can benefit from new products that diversify their offerings and appeal to customers. For example, home improvement, electronics, sporting goods, and other types of retail stores, as well as sporting and recreational venues often look for new products that they can add to their inventory to attract customers, such as male customers.

Accordingly, there is a need for a new marketing model for marketing beauty products to male customers at male-frequented venues.

### SUMMARY OF THE INVENTION

The present invention relates to a system and method of marketing beauty products, and more particularly to a system and method of marketing beauty products to male customers in a male-frequented setting. In one embodiment, the method includes obtaining a display having advertising space for beauty products, locating the display in a male-frequented venue, and providing information about and access to the beauty products at the display. The display may be, for example, a freestanding kiosk or display case. The male-frequented venue may be an automotive store, such as an automotive parts store or service center, or a non-automotive store or venue, such as an electronics or home improvement store or sports arena. The display and/or the beauty products can be configured to match one or more characteristics of the male-frequented venue, such that the beauty products blend in with the surrounding environment. For example, at an automotive venue, the beauty products can be advertised with automotive terminology and themes, and the beauty products can be packaged and labeled to match automotive products. By leveraging the characteristics and features of the male-frequented venue with which the customers are already familiar and comfortable, this system presents new products to the customers of the venue in a familiar and recognizable way. The system thus encourages customers to approach and learn about the beauty products, and ultimately to buy the products and incorporate them into a healthy lifestyle. The method provides a cost-effective, economical, convenient, comfortable, reliable, and private way to advertise and provide access to beauty products directly to target consumers without the disadvantages related to marketing through traditional advertising and retail channels.

In one embodiment, a system for marketing beauty products to male customers includes a beauty product for a male customer; a male-frequented venue conducting a primary line of business that is unrelated to the beauty product; a visual display located at the male-frequented venue and providing information about the beauty product; and a product identifier dispensed at the male-frequented venue and identifying the beauty product. The beauty product is configured to include a characteristic of the primary line of business of the male-frequented venue.

In one embodiment, a system for selling beauty products to male customers includes an automotive venue providing an automotive service or product; a beauty product configured to embody a characteristic of the automotive service or product; and a visual display located at the automotive venue including an automotive graphic providing information about the beauty product.

In one embodiment, a method for marketing a beauty product to a male customer includes providing an automotive product or service at a male-frequented venue that has a primary automotive business unrelated to beauty products; providing a visual display having information about beauty products targeted to male customers; configuring the beauty products to include a characteristic of the automotive product or service; placing the visual display at the male-frequented venue; placing beauty products at the male-frequented venue; and offering beauty products for sale at the male-frequented venue.

In one embodiment, a method for marketing a beauty product to a male customer includes providing an automotive product or service at a male-frequented venue that has a primary automotive business unrelated to beauty products; providing a webpage having information about a beauty product targeted to male customers and having an automotive characteristic; providing a visual display having information about the beauty product, the visual display providing an address for the webpage for the beauty product; and placing the visual display at the male-frequented venue.

In one embodiment, a packaging container for a grooming product targeted to male customers includes a box portion having a front panel and a back panel; a grooming product located in the box portion; and a window in the front panel of the box portion for viewing the beauty product. The packaging container is configured to resemble a bottle of motor oil, to associate the grooming product with automobiles

In one embodiment, a method for marketing beauty products to male customers includes providing a non-beauty related service at a male-frequented venue that has a primary line of business unrelated to beauty products, providing a visual display having information about beauty products targeted to male customers, placing the visual display at the male-frequented venue, placing beauty products at the male-frequented venue, and offering beauty products for sale at the male-frequented venue. The beauty products include a characteristic of the non-beauty related service, such as an automotive-themed graphic, label, or instructions.

In another embodiment, a method for marketing beauty products to male customers includes providing a non-beauty related service at a male-frequented venue that has a primary line of business that is unrelated to beauty products, and providing at the male-frequented venue a visual display having information about beauty products targeted to male customers. The visual display is configured to prompt interest of the male customers in the beauty products. For example, the visual display may include graphics, symbols, and instructions that match the graphics, symbols, and instructions at the male-frequented venue. The method also includes providing at the male-frequented venue additional information about the beauty products in response to the male customer's reaction to the visual display, dispensing at the male-frequented venue a product identifier for the beauty product, and providing the beauty product to the male customer based on the product identifier.

In another embodiment, a method for marketing beauty products targeted to males includes obtaining a visual display having information about beauty products targeted to males, providing the visual display at a male-frequented venue having a primary line of business that is unrelated to such beauty products, configuring the visual display to draw a male customer's attention to the visual display, providing additional information about such beauty products to the male customer at the visual display in response to drawing the customer's attention, and distributing at the male-frequented venue material identifying the beauty products. The material could be, for example, a flyer for the beauty products that is formatted and organized as a flyer for a service or product offered by the primary line of business, such as an oil change or other automotive service. The flyer follows the template for an automotive flyer, with similar colors, terminology, and graphics, to advertise the beauty products.

In another embodiment, a system for marketing beauty products targeted to male customers includes a male-frequented venue conducting a primary line of business that is unrelated to such beauty products, a visual display provided at the male-frequented venue and displaying information about the beauty products, and means located at the male-frequented store for dispensing a product identifier to identify the beauty products. The visual display is configured to draw a male customer's attention.

In another embodiment, a system for marketing beauty products to male customers, includes a visual display located at a male-frequented venue and having information about beauty products targeted to male customers. The visual display is configured to prompt interest of the male customers in the beauty products. The system also includes means for providing at the male-frequented venue additional information about the beauty products in response to the prompted interest of the male customer, means for dispensing at the male-frequented venue a product identifier for the beauty product, and means for providing the beauty product to the male customer based on the product identifier.

### BRIEF DESCRIPTION OF THE DRAWINGS

FIG. 1A is a front elevational view of a marketing system according to an embodiment of the invention;

FIG. 1B is a side elevational view of a marketing system according to an embodiment of the invention;

FIG. 2 is a perspective view of a marketing system according to an embodiment of the invention;

FIG. 3 is a flow diagram of a process for marketing beauty products according to an embodiment of the invention; and

FIG. 4 is a flow diagram of a process for marketing beauty products according to an embodiment of the invention;

FIG. 5 is a flow diagram of a process for marketing beauty products according to an embodiment of the invention; and

FIG. 6 is a flow diagram of a process for marketing beauty products according to an embodiment of the invention.

FIG. 7 is a front perspective view of a system for marketing beauty products at a male-frequented venue according to an embodiment of the invention.

FIG. 8 is a front view of a beauty product configured to match a characteristic of an automotive venue, according to an embodiment of the invention.

### DETAILED DESCRIPTION OF THE INVENTION

The present invention relates to a system and method for marketing beauty products, and more particularly to a system and method for marketing beauty products to male customers in a male-frequented setting. The method includes providing a visual display at a location where male customers are generally present, although they may or may not be intending to shop for beauty products. The visual display can include information about the beauty products for sale, including brochures, advertisements, posters, and other paper or electronic display medium. Information on the beauty products can also be provided by a telephone help line, website access, and/or an audio device. Customers who arrive at the location for other purposes, such as to drop off a car for maintenance or repairs or to shop for sporting goods equipment, hardware, or electronics, can view the display and decide on their own whether or not to approach it to find out more information about the products offered. The visual display can include or be provided in conjunction with storage space for the beauty products for sale, so that a customer can simply pick up a product and purchase it at the counter along with the other goods or services that the customer intends to purchase.

In one embodiment, a system for marketing men's beauty products at a male-frequented venue is integrated seamlessly with the venue by incorporating characteristics or features of the venue. The visual display, product identifiers, and beauty products themselves are configured to match one or more characteristics of the male-frequented venue, to present a uniform visual impact that blends in with the surrounding environment. The visual displays, product identifiers, beauty products, and other components of the system use packaging styles, terminology, instructions, labels, and graphics that are used by the non-beauty service provided at the male-frequented venue. As a result, the system presents new products to the customers of the venue in a familiar and recognizable way. The system thus encourages customers to approach and learn about the beauty products, and ultimately to buy the products and incorporate them into a healthy lifestyle.

As used herein, the term “male-frequented store” or “male-frequented venue” is not limited to a store or venue that caters to or attracts only male customers. Instead, it simply means a store or venue that does attract a large number of male customers from the general male population. Of course, the store or venue can be one with a majority of male customers, such as a store or venue that attracts predominantly male customers. In some embodiments, the male-frequented venue is one that primarily targets male customers and that attracts male customers disproportionately to female customers. Exemplary embodiments of the invention are directed to male-frequented venues whose core or primary business is unrelated to grooming or beauty products. For example, this would exclude a barber shop or male hair salon. Additionally, the term “store” includes but is not limited to retail stores, service shops, and service stations. The term “venue” includes but is not limited to stores and sporting and recreational arenas. Finally, male customers are considered to be adult male customers, rather than children.

The present invention provides a system and method for marketing beauty products to male customers at these male-frequented venues. The method includes providing on a visual display information about beauty products targeted to males, and providing the visual display in a retail space or a waiting area of a male-frequented venue, such as an automotive parts store, an automotive service station, or a home improvement store. In one embodiment, the method also includes providing advertising and information about the beauty products on the display, providing beauty products at the store, and making the beauty products available for purchase at the store. In one embodiment, the visual display is a kiosk or part of the kiosk which captures the interest of a male customer as the male customer waits for a non-beauty related service provided by the male-frequented venue. The visual display may capture the customer's interest by including images and phrases that are frequently used by the primary business of the male-frequented venue and that are recognizable and familiar to the customer.

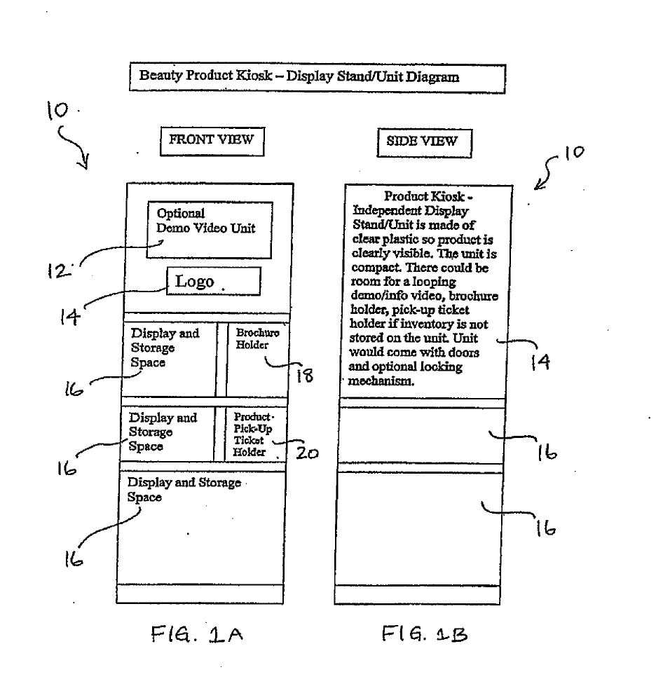

An embodiment of a system for marketing beauty products is shown in FIGS. 1A and 1B. In the embodiment shown, the system includes a kiosk 10 which may be a stand alone, self-supporting display that can fit into a specific location of a retail store or a waiting area. The kiosk 10 includes a video unit 12, such as a television running a recorded program about the products for sale, or a computer monitor running software about the products or offering access to the beauty supplier's website. Advertising space 14 is provided around the kiosk for informational and promotional displays, such as electronic displays or paper displays. The kiosk 10 also includes storage space 16 for the beauty products offered for sale, and a holder 18 for brochures, flyers, or other handouts.

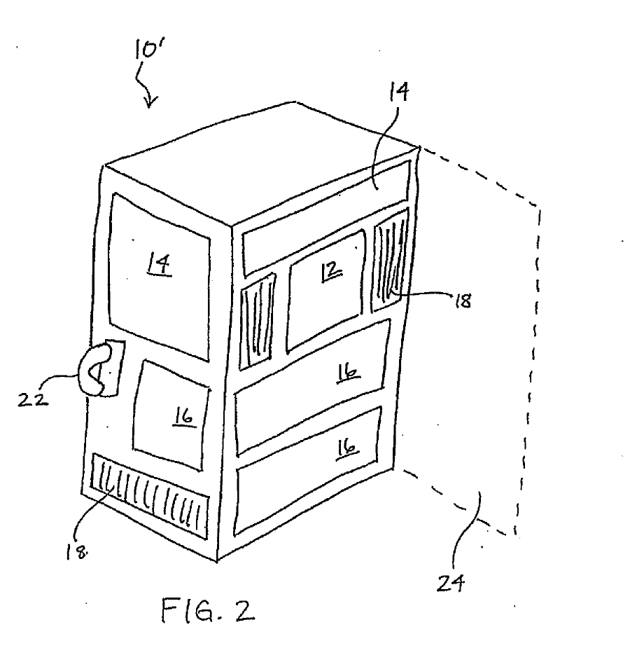

The kiosk 10 may include a ticket dispenser or holder 20 for dispensing a product identifier such as product pick-up slips or tickets, which the customer can take to a sales representative or cashier who will obtain the corresponding beauty product from behind a counter, locked cabinet, or other restricted area. In this regard, the slips or tickets identify the product to be purchased. Furthermore, instead of manually carrying the slip or ticket to the cashier, the slip or ticket may be electronically communicated to the cashier over a wired or wireless data communications link. These pick-up slips can be used to advertise the beauty products on the kiosk when the products themselves are not stored on the kiosk. In that case, the kiosk 10 may appear as the kiosk in FIGS. 1A, 1B, and 2 but without the storage spaces 16. When pick-up slips are used, the storage spaces 16 are not needed at the kiosk itself, and as a result the storage spaces 16 may be replaced with other informational displays and holders, such as advertising space 14, brochure holders 18, ticket holders 20, and video displays 12.

Although the embodiments of the system in FIGS. 1A-2 show the various components of the system in a self-contained kiosk, a person of skill in the art should recognize that the various components may be spread out throughout the male-frequented venue or may even include components (e.g., web servers) outside of the male-frequented venue.

In another embodiment, the beauty products are not actually sold at the male-frequented venue. Like the ticket-holder embodiment, the kiosk 10 or other visual display will include informational displays such as advertising space 14, brochure holders 18, and video displays 12, but need not include actual storage space for the beauty products. In this embodiment, the visual kiosk 10 dispenses a product identifier such as informational handouts, flyers, brochures, and/or free product samples that identify the beauty product (for example, by name or product number) and direct the male customer to a website, phone number, or other retail store where the beauty products may be purchased. For example, in this embodiment, the kiosk 10 from FIGS. 1A and 1B includes no storage space 16, but instead includes a video, brochures, electronic media such as cd's and dvd's, and/or free samples that inform the customer that the advertised beauty products are available for purchase at a particular website or store. In this way, the beauty product supplier can advertise to a male audience at the male-frequented venue, but the beauty products do not actually have to be kept in stock at the store.

The product identifier dispensed at the male-frequented venue identifies the product to be purchased. It may be a paper ticket, a flyer, brochure, or other similar handout, or a free sample of the beauty product. The product identifier may include, for example, a product name, SKU number, UPC code, bar code, product description, the product source, or any other information that identifies the beauty products. The product identifier can also be provided as an electronic message, such as an email, e-ticket, or text message that identifies the beauty products and/or the source of the beauty products, such as the supplier and its website address. For example, the customer can sign up to receive emails about the beauty products, and then the customer can read about the product at home and go to the beauty supplier's website to purchase the products. In one embodiment, the user uses the computer at the visual display to order products from the beauty supplier's website, and the customer receives an e-mail or text confirmation of the order. The user can also log in to the website and add products to a virtual shopping cart, to be purchased later. Thus, the product identifier can be an electronic ticket, receipt, or message that the user will access later on his cell phone or computer.

The kiosk 10 can include a communications device that communicates over a communications network to provide information to the customer. The communications network may be any wired or wireless communications network conventional in the art, such as, for example, a local area network, a private wide area network, or a public wide area network such as the Internet. For example, the kiosk 10 may include a computer that accesses the beauty supplier's website over the Internet. The customer can peruse the website at the kiosk, and can even place an order there. The computer can process a customer's order via the Internet. Instead of or in additional to placing an order, the customer can sign up for e-mails or text messages with information about the beauty products. In other embodiments, the communications device is a telephone, and the customer can call for information about the products and can place orders over the phone.

When the beauty products are in fact sold at the male-frequented venue, the cashier that makes the final sale of the beauty product is the same cashier that makes sales of products or services that are the store's primary line of business. That is, the beauty products do not require a separate cashier or checkout counter, but instead can be purchased at the regular cashier or checkout counter that the customer would normally use when purchasing non-beauty products from the store. Thus, the male-frequented venue can provide a non-beauty service or product (such as oil changes or automotive parts) and also provide the beauty products, without needing a separate cashier or separate employees.

A side view of the kiosk 10 is shown in FIG. 1B, showing additional storage space 16 and advertising space 14. The different features on the kiosk are optional, and the kiosk 10 can be customized for each beauty supplier to include the desired configuration of product storage, informational displays, advertising, video displays, etc.

A kiosk 10′ according to another embodiment of the invention is shown in FIG. 2. This kiosk 10′ also includes an optional help line telephone 22, which the customer can use to call the manufacturer of the beauty product with questions about the product. The kiosk 10′ may display various help line telephone numbers for the customer to call. The customer could call with a cell phone or use the telephone 22, if present.

The kiosk 10′ also includes an optional door or wall 24 that extends from a side of the kiosk 10′ to shield the customer from view, in order to provide some privacy while the user is viewing the beauty product displays. While only one wall 24 is shown, the kiosk 10′ could have several walls in various locations to provide customer privacy. These walls 24 can be movable so that the kiosk can be arranged in various configurations to be more open or more private. The kiosk 10′ can also be closed and locked when not in use, to protect the advertising displays and/or beauty products inside the kiosk. The kiosk provides a comfortable, relaxed, and convenient environment with no sales pressure, where customers have plenty of time to spare (for example, those having nothing important to do while waiting for their automotive service) and where they can give undivided attention to something that catches their eye, such as a display provided via the kiosk with some initial information about the beauty product. Once the customer's initial interest is prompted via the display, the customer can obtain additional infoimation on the beauty product from the kiosk or at some other location at the male-frequented venue that provides additional information (such as flyers, brochures, video displays, etc.), as the customer waits for the non-beauty related service.

The system for marketing beauty products can include a self supporting kiosk, an independent freestanding display, a display case, a video, or a counter-top, table-top, or wall display. In one embodiment, the system for marketing beauty products includes a vending machine. The vending machine is configured to receive identification of the beauty product and associated payment information, and then dispense the product from the vending machine automatically instead of having a cashier manually retrieve and provide the product to the customer. According to another embodiment, the system includes advertising space, informational displays, visual display(s), storage space, and supporting structure. When the visual display is a counter-top or table-top display, it may be designed to sit on top of an existing counter or table, or it may also include its own supporting table or stand. In one embodiment, the system is a kiosk that includes (1) storage space for beauty products for sale that can easily be picked up and examined in detail by customers; (2) appropriate educational material, leaflets, brochures, flyers, and booklets for the products on sale or displayed; (3) a clearly visible phone number (and optionally a courtesy phone) for a telephone hotline or technical support line where customers can call in with their questions; (4) a clearly visible web address (and optionally a computer with access to the web address) where a potential customer can go to ask questions or obtain more information about the products on display; and (optionally) (5) a video display that repeats product information to help facilitate the customer's decision in purchasing the products on display. This video display could include touch screen features to interact with the customer to answer commonly asked questions or provide product highlights. The video itself may be the entire visual display, without any other supporting structures or features, or the video may be incorporated into a larger visual display with other features such as a kiosk, storage space, and other structures, as shown in FIG. 1A.

In one embodiment of the invention, a system and method of marketing beauty products to male consumers includes providing a visual display that is configured to match or include one or more characteristics of the non-beauty venue where the visual display is located, such that the beauty products blend in with the surrounding environment. For example, at an automotive venue, the beauty products can be advertised with automotive terminology and themes, and the beauty products can be packaged and labeled to match automotive products. By leveraging the characteristics and features of the male-frequented venue with which the customers are already familiar and comfortable, this system presents new products to the customers of the venue in a familiar and recognizable way. The system thus encourages customers to approach and learn about the beauty products, and ultimately to buy the products and incorporate them into a healthy lifestyle.

The visual display of the beauty products and the environment of the male-frequented venue where the products are displayed work together to attract the male customer, educate the customer, and make the sale. As discussed above, the automotive environment, e.g. the showroom, display, and waiting areas of venues that serve the functions of vehicle sales, maintenance and repairs, traditionally cater to male consumers. Their captive male audience is an optimal environment and timing to educate men about the need for proper beauty care. At the automotive venue (or other male-frequented venues described herein), the environment is relaxed and non-threatening, and the male customer typically is comfortable shopping and voluntarily sharing his attention. Many traditional beauty retailers cater to female customers and typically do not attract a large male audience, to educate them about the benefits of a proper beauty routine. In the automotive industry, a captive audience of both men and women is a core advantage of the business.

However, despite the ability to capture an audience, the automotive industry does not currently have a coordinated strategy to utilize this window of opportunity. The critical 15 to 60 minute window when a customer waits for an oil change, brake service, tires or other services is a valuable time to educate this audience about new products and concepts, such as beauty products and the importance of a healthy skincare routine. For the automotive industry, this is also an opportunity for supplemental income in a highly competitive industry. A captive audience that is persuasively educated about the importance of a proper beauty routine would be highly motivated to purchase the beauty products on display in the automotive venue.

The comfortable environment of the automotive (or other male-frequented) venue addresses the physical barrier that has often prevented male customers from shopping for beauty products at beauty retail shops. In a further embodiment of the invention, the visual display, product identifiers, beauty products, and other components of the system are not only located at the male-frequented venue, but are configured to match, resemble, or indicate one or more characteristics of the male-frequented venue. The beauty products thus blend in seamlessly with the surrounding environment and present a familiar and recognizable visual invitation to the customer. The integration of the beauty system with the non-beauty products and services offered at the male-frequented venue helps to attract the male customers to the beauty products by presenting characteristics with which the male customers are already familiar and already understand.

Thus, the male-frequented venue offers the opportunity to reach a captive audience of male customers in a relaxed and natural setting, and thereby addresses the physical barrier that has often prevented male consumers from shopping for beauty products at retail beauty and department stores. The configuration of the system to match the non-beauty business offered at the venue addresses the psychological barrier by attracting the male customers to the display and then educating and convincing them of the need for proper skincare. The configuration of the system to match the non-beauty business also serves to overcome the psychological barrier of the business owner as well as the male customer. For example, the configuration of the beauty products with an automotive theme helps to overcome any hesitation on the part of the automotive shop owner to offer the beauty products for sale, as the products fit in with the environment and do not look out of place.

Thus, according to embodiments of the invention, a visual display is provided at a male-frequented venue and is configured to match the surrounding environment of the male-frequented venue. The visual display serves the function of attracting the male customer's attention, educating the male customer about the products and brands in a familiar and understandable way, and dispensing product identifiers (brochures, flyers, etc.) that identify and provide additional information about the products. The beauty products themselves may also be configured to match or include a characteristic of the male-frequented venue.

For example, in one embodiment, the venue is an automotive venue, and brochures, visual display(s), beauty products, and product identifiers are designed with automotive themes and extensive automotive analogies to fit seamlessly into the automotive environment, to identify and disseminate information about the featured beauty products in a way that appeals to male customers and educates the customers about the proper use of men's beauty products through familiar automotive analogies. The use of graphics and terminology that closely mimic automotive aftennarket products familiar to men can be further complemented by product logos and tag lines that are distinctively automotive. Using graphics, packaging, terminology, and visual materials (brochures, flyers, samples, etc) that mimic those of common automotive products promotes concept familiarity and enhances the masculine theme for the beauty product.

Automotive-themed graphics, labels, and instructions can be incorporated into the beauty products, visual display, and other associated materials. The material could be, for example, a flyer for the beauty products that is formatted and organized as a flyer for a service or product offered by the primary line of business, such as an oil change or other automotive service. The flyer follows the template for an automotive flyer, with similar colors, terminology, and graphics, to advertise the beauty products. The visual display may include graphics, symbols, and instructions that match the graphics, symbols, and instructions of the male-frequented venue. As an example, the materials may include the tag line “Time to Put Your Face on a Maintenance Schedule” to embody the popular automotive practice of putting cars on a maintenance schedule. As another example, the slogan “Keep it Clean. Keep it Lubricated. Keep it Protected” is commonly used to describe aftermarket products for keeping an engine clean/free of gunk, lubricated with proper grade/type of oil, and protected via additives to minimize friction. The same slogan can be included on the beauty product display to integrate the display with the surrounding automotive venue and to educate the male customers through analogies to automotive activities.

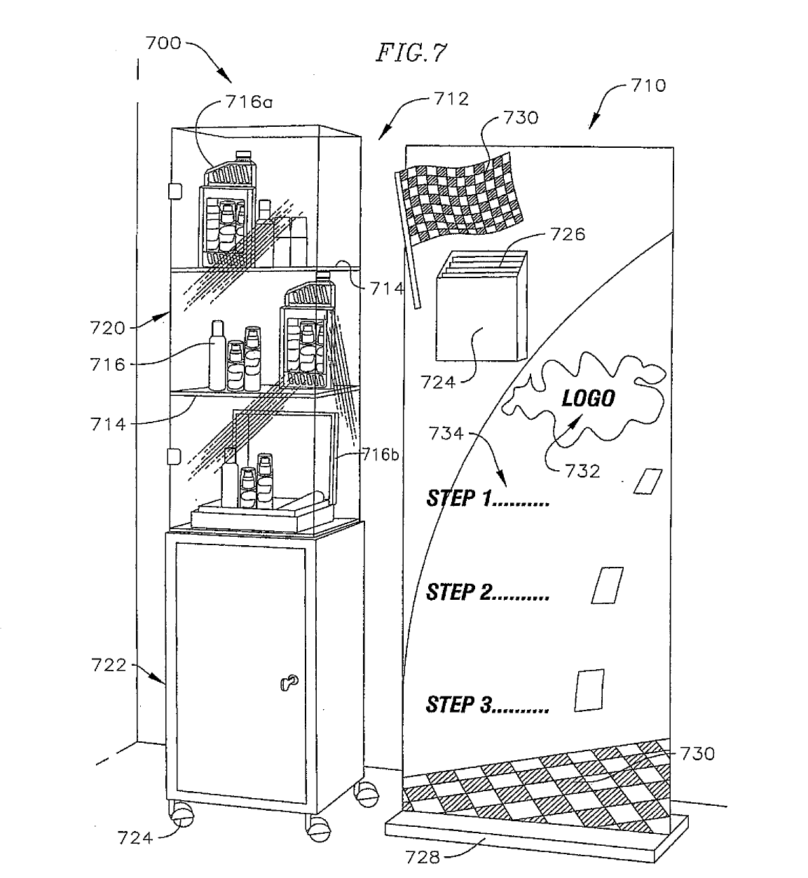

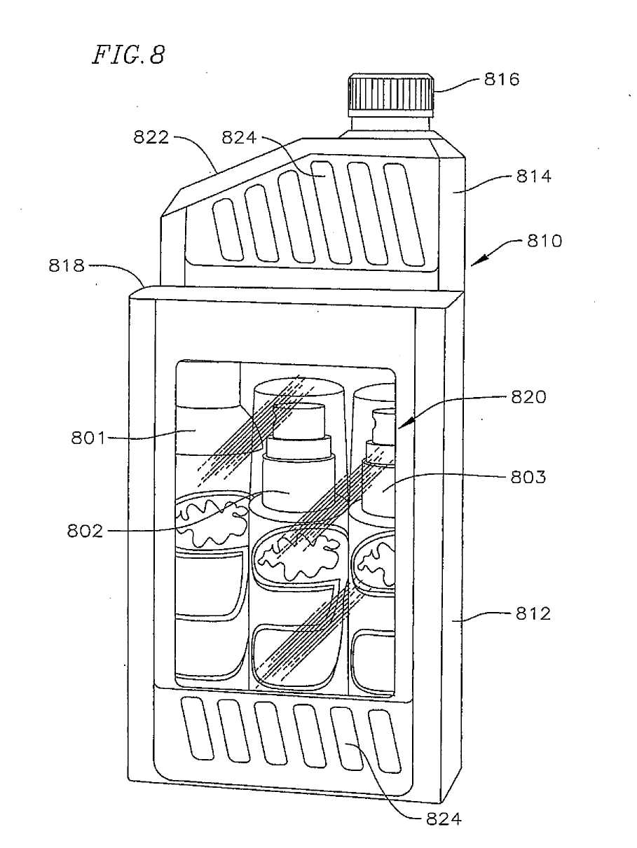

In another embodiment, the beauty products themselves are configured to resemble other non-beauty products offered at the male-frequented venue. In one embodiment, the outer packaging for the male beauty products is dimensioned and configured to embody automotive characteristics, such as being formed in the shape of a typical 1-quart motor oil bottle (see FIGS. 7-8 and discussion below). In other embodiments, the outer packaging is configured in the shape of other familiar automotive products, such as an additive bottle, coolant bottle or jug, a bottle of fuel system /automatic transmission fluid system/engine treatment or protectant, gasoline pump, car battery, tire, car, or truck. In other embodiments, the outer packaging is configured in the shape of familiar sports products, such as a football helmet, football, baseball, basketball, soccer ball, or 3-pack of golf balls. In another embodiment, the beauty products are packaged in an outer packaging box that is configured as a cigar box, for example, made of wood and lined with felt.

Other examples include visual displays, product identifiers, beauty products, and other components that use packaging styles, terminology, instructions, labels, and graphics that are used by the non-beauty service provided at the male-frequented venue. Where the venue is automotive, the graphics could include recognizable automotive graphic such as a checkered flag, a monster truck, a race car, a sports car, a drop of motor oil, a motor oil bottle, a race track, a traffic cone, a tire, and a traffic sign. The graphics could include silhouettes of familiar automotive images (sports cars, etc.) or other accents, stripes, patterns, colors, etc. that refer to automotive concepts. These graphics can be provided on the visual display, product identifiers, and the beauty products. In one embodiment, the venue is an automotive service shop that offers an automotive service that follows a two- or three-step process, such as a three-step cleaning process for cleaning fuel systems and engines. The beauty products and associated materials incorporate the same two or three steps, such as Step 1: Cleaner, Step 2: Treatment, Step 3: Protectant. The beauty products can be configured to include other instructions, methods, or steps that are utilized by automotive (or other male-frequented) venues.

In another example, the packaging and/or the visual display for the beauty product utilizes terminology and vocabulary from the male-frequented venue. That is, the terminology for the product is aligned with the industry of the male-frequented venue. For example, in one embodiment the venue is an automotive venue, and the visual display and product packaging for the beauty product include automotive terminology and vocabulary (e.g., protectant, hi-potency, three-step system, performance, maintenance, etc.). In a further embodiment, the packaging and/or the visual display for the beauty product omits standard terminology typically used on many retail beauty products (e.g., cleanser, moisturizer, etc.), to further distinguish the product from other beauty products.

An embodiment of a system 700 for selling beauty products targeted to male customers is shown in FIG. 7. The system includes a visual display 710 and a display case 712 which includes one or more product display shelves 714 displaying one or more beauty products 716a, 716b. The beauty products 716a, b may be packaged in an outer packaging 716a shaped as a motor oil bottle, or another packaging 716b configured as a cigar case, just as a few examples. The beauty products and the product display shelves are located in an upper portion (or product display portion) 720 of the display case 712. A lower portion of the display case includes a storage unit 722 where additional products and materials can be securely stored.

The floor display and brochure holder also serve an important function to disseminate detailed product information, educational materials, and brand specific point of purchase materials related to the men's beauty products. Collectively, the abovementioned point of purchase materials are in fact product identifiers that serve to identify the male beauty products.

The visual display 710 includes information about the beauty products. In one embodiment the visual display includes a dispenser for product identifiers, such as a brochure holder 724 for brochures 726. The visual display may include a floor stand 728 for resting on the floor or on a counter or table, or the display may be mounted on a wall or other location. The visual display may also include one or more automotive graphics 730, such as a checkered flag or finish line. The visual display may include a logo or slogan 732 which matches familiar automotive slogans, tag lines, colors, fonts, and graphics. The visual display may also include instructions 734 that match familiar automotive service instructions. The visual display may include other components such as graphics, instructions, templates, colors, images, symbols, phrases, formats, and labels that incorporate a characteristic of the male-frequented venue, such as an automotive characteristic.

In one embodiment the display case 712 has a small foot print of 12¾″ W×12¾ L×60″ H″. The mobile product display is compact to accommodate smaller automotive venues and for ease of moving the display to different locations within the automotive venue. The display case may include wheels 724 for easy portability and transportation of the case. The display case 712 may be situated next to the floor display and brochure holder for maximum marketing impact.

In one embodiment, the mobile product display and storage unit 712 has two separate locking mechanisms to prevent product theft. The upper display section 720 of the mobile display and storage unit has a locking mechanism and is generally made of clear fiberglass material with adjustable shelves 714 instead of glass for ease of shipping and to minimize the safety concerns of the retail venues and service centers. The actual male beauty products or sample products 716 generally referred to and described in the aforementioned visual floor display and brochure holder and the product information brochures/point of purchase materials are showcased inside this display and storage unit for maximum marketing efficiency, so that customers can immediately see the actual beauty product referenced in the floor display and the point of purchase materials.

The bottom portion 722 of the mobile product display and storage unit has a separate locking mechanism and in one embodiment includes a base cabinet made of powder-coated sheet metal. This base cabinet is ideal to use as storage space for inventory of the male beauty products displayed on the upper showcase portion and extra supplies of point of purchase product brochures and educational materials.

As shown in FIG. 8, in one embodiment one or more beauty products 801, 802, 803 are packaged in an outer packaging 810 that is dimensioned to resemble a bottle of motor oil. Specifically, the outer packaging 810 comprises a lower box portion 812 and an upper flap portion 814. The beauty products 801, 802, 803 are located in the lower box 812, which includes a window 820 for viewing the beauty products 801, 802, 803. The packaging includes a step or shelf 818 between the two portions 812, 814. The upper flap portion 814 is an extension of the back panel of the box 812, and it extends upwardly above the top of the box to resemble the top section of a motor oil bottle. This top portion includes a depiction of a round cap 816 at the top of the packaging 810, similar to a screw-on cap of a bottle of motor oil. The upper portion 814 also includes an angled edge 822 on one side of the cap 816. The upper and/or lower portions may include matching lines or indentations 824 that resemble grooves for gripping the packaging and giving it an automotive look. The shape and characteristics of the upper portion 814 give the packaging 810 the shape of a bottle of motor oil, which may be referred to as a “motor oil bottle shape.”

The integration of the male-frequented environment with the beauty product displays and packaging makes an effective analogy between skin maintenance and car maintenance, making the concept of men's skincare more comfortable and logical to male customers. Following the concept of utilizing familiar automotive routines as a new approach to help men understand the concept for proper masculine skincare by making the analogy between the need for proper vehicle maintenance and proper skincare, automotive aftermarket products are the perfect starting point upon which to base the packaging for men's beauty products. The inherent characteristics of automotive aftermarket products geared toward cleaning, maintenance and repair are also shared by basic skincare products, with the advantages of a male-frequented framework. Thus, the product packaging and visual display align the concept of men's skincare with a non-beauty and male-frequented activity, in this case, car maintenance and repair.

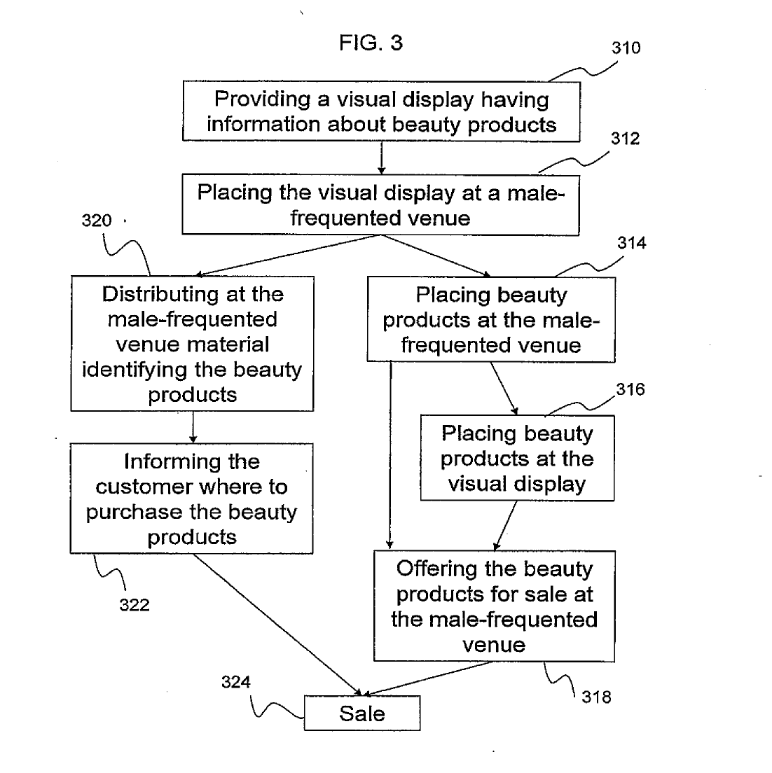

FIG. 3 is a flow diagram of a process for marketing beauty products to male customers according to one embodiment of the invention. The process includes providing a visual display (such as a kiosk) having information (such as initial product information) about beauty products 310, and placing or locating the visual display in a male-frequented venue 312. Thus, the method includes providing information about and (optionally) access to beauty products at the visual display. The method may include placing the beauty products at the male frequented venue 314, and optionally at the visual display 316 (e.g., on a counter or shelf of the kiosk 10). When the products are located at the venue, the method includes offering the products for sale at the venue 318. After the customer selects and picks up the product from the kiosk (or takes a pickup slip that refers to the actual product if the actual product is stored in a separate storage area in another section of the store), the customer can just pay for (and pick up) the product with the cashier. The venue's cashiers and employees do not need to interact on behalf of the beauty product to make the sale, nor do they need to have any product specific training or knowledge. In another embodiment, where the beauty products are not kept in stock at the venue, informational materials that direct the customer to a website, retail store, or other place where the customer can purchase the beauty products are made available at the venue. In this case, the method includes distributing at the male-frequented venue material identifying the beauty products 320 and informing the customer where to purchase the beauty products 322. As discussed above, this can include dispensing a product identifier such as a paper ticket or e-ticket. As shown in FIG. 3, the method may result in a sale 324 of beauty products to the male customer, whether or not the beauty products are located at the venue.

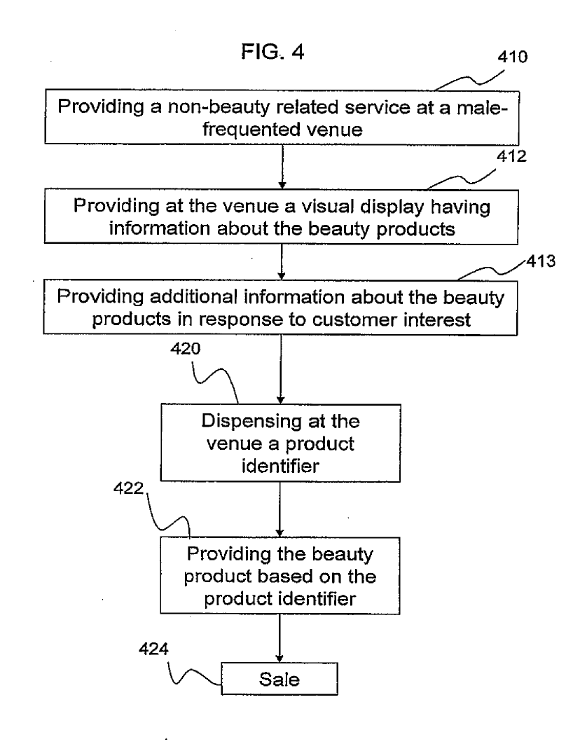

FIG. 4 is a flow diagram of a process for marketing beauty products according to another embodiment of the invention. According to this embodiment, a non-beauty related service is provided at a male-frequented venue 410. The male-frequented venue has a primary line of business that is unrelated to beauty products, such as automotive retail sales, automotive service, sports equipment sales, etc. This service is provided at the male-frequented venue. For example, in one embodiment the venue is an oil change service shop, and the method includes conducting oil changes or automotive repairs at the shop. This can be carried out with traditional oil changing and repair machinery and equipment at the service shop. In another embodiment, the venue is a sporting goods store, and the method includes selling sports equipment at the store. The venue and its non-beauty service include distinctive characteristics that can be incorporated into the beauty products and visual display, as described above.

The method also includes providing at the venue a visual display having information about beauty products targeted to males 412. The visual display is configured to prompt the interest of male customers at the venue. The customer's interest can be drawn to the display by including appealing advertisements, product displays, free samples, videos, and other features that can attract the customer's attention. Thus, the visual display may be a signage (electronic or otherwise), samples of the product, or any other visual material that attracts the customer's attention. In one embodiment, the visual display is designed to attract the attention of male customers waiting for automotive service at an automotive service shop. In another embodiment, the visual display is designed to attract the male customer's attention by matching one or more distinctive characteristics of the non-beauty service offered at the venue, such as by using automotive or sports themes, graphics, packaging, and labels.

The method also includes providing additional information about the beauty products at a specific location within the venue, in response to drawing the customer's interest 413, such as when the customer approaches the visual display or informational material to learn more about the beauty products. The additional information can be provided on flyers, brochures, product samples, and other handouts that provide more detailed information about the beauty products. The visual display can also provide a computer where a customer can browse the beauty supplier's website, a video that gives additional information about the products, a telephone so the customer can call a help line to find out more information, and/or other displays that provide detailed information about the products.

In step 420, the customer receives a product identifier dispensed at the store or venue, and the identifier has a product name, SKU number, UPC code, bar code, description, and/or the like. The product identifier may be a paper ticket, flyer, brochure, or the like, or it may be electronically provided to the customer's cell phone, computer, or PDA, or to a computer accessible by the store clerk or by an off-site provider. Alternatively, the product identifier may be encoded in an electronically readable medium (e.g., a barcode) and provided to a reader that retrieves the product information from the electronically readable medium.

In step 422, the beauty product is provided to the customer based on the product identifier. In this regard, if the product is available at the venue, the product is provided to the customer and sold 424 at the venue. For example, the product may be dispensed from a kiosk, vending machine, or from an attendant at the venue. Alternatively, the product is ordered from the venue by transmitting the product identifier to a fulfillment center, and the product is delivered to the customer from the fulfillment center. In yet another embodiment, the customer simply takes the dispensed product identifier and makes the purchase at a later time or places the order from home or another location, resulting in sale 424.

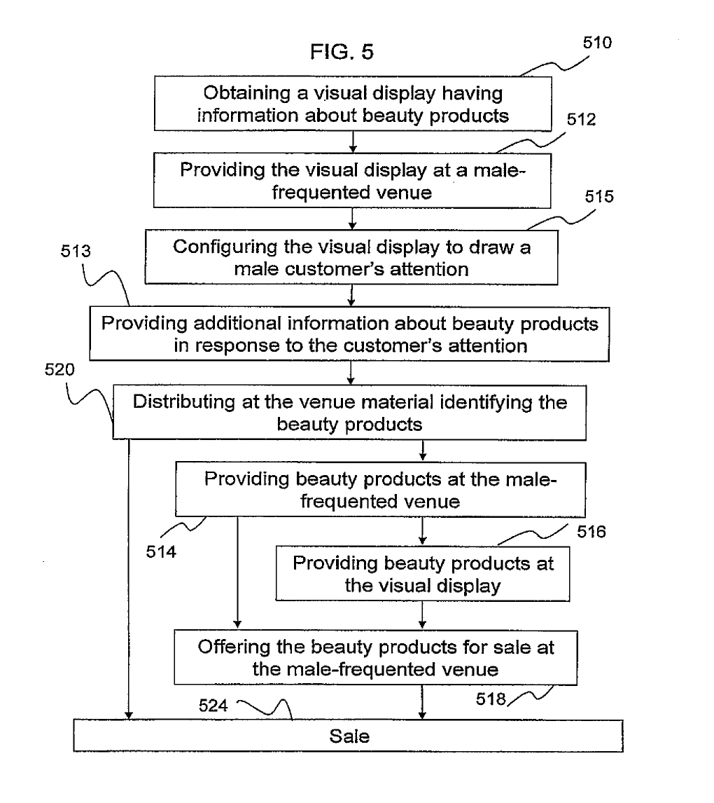

FIG. 5 is a flow diagram of a process for marketing beauty products according to another embodiment of the invention. The method includes obtaining a visual display having information about beauty products targeted to males 510, and providing the visual display at a male-frequented venue 512. The method also includes configuring the display to draw a male customer's attention 515, and then providing additional information about the beauty products to the customer in response to the customer's attention 513. The method includes distributing at the venue material identifying the beauty products 520, such as a product identifier. If the products are stored at the venue, the method includes providing the beauty products at the venue 514, optionally providing them at the display 516, and offering them for sale at the venue 518.

In one embodiment, the method also includes monitoring the purchasing habits and preferences of the customers. The male-frequented venue where the kiosk is located can monitor the number of customers who approach the kiosk, the number of customers who take flyers or call the help line phone number, and the number of sales. The venue can also adjust the kiosk to include more or less privacy, with the optional walls 24, and monitor whether this increases the number of customers who approach the kiosk.

In one embodiment, the method also includes using the existing knowledge and expertise of a male-frequented business regarding purchasing preferences of male customers. The male-frequented business may have expertise in approaching male customers with new concepts, new products, and targeted marketing campaigns that appeal the male customer preferences. For example, an automotive service center can use its experience with male customers to place the visual display in an area where the customers are likely to notice it, and to configure the visual display to match the graphics, symbols, instructions, and other components of the automotive service center, in order to attract the male customers. As another example, an automotive parts store can locate the visual display in a particular area of the store where its customers are comfortable browsing. A home improvement, sporting goods, or electronics store can do the same. The beauty supplier can rely on the expertise of the male-frequented venue to cater to the shopping preferences of the male customers. Furthermore, when the employees of the male-frequented venue are male employees, the visual display markets beauty products to these employees as well as to the venue's male customers. The venue's male employees are a significant segment of the male population and inherent male customer base that has traditionally been difficult to reach because existing retail channels for men's beauty products do not adequately address their shopping preferences, nor cater to their beauty needs.

In one embodiment, the method includes providing the visual display and/or products free of charge to the male-frequented venue. For example, in the automotive industry, retail automotive stores are looking for add-ons and other products to offer to the end customer, and wholesale automotive suppliers are likewise looking for new ways to sell their products. Suppliers typically offer incentives to their customers (usually dealerships, quick oil change stores, and repair-maintenance stores) to make a sale. For example, major oil companies compete with each other by offering free service equipment to quick lube operators as an incentive for them to sign a multi-year supply contract. This practice is not limited to oil distributors, but is also used by distributors and suppliers of auto parts (from fan belts, filters, batteries to tires), lubricant additives and cleaners (fuel additives to engine treatment), shop supplies (parts washers and floor cleaners).

However, in the past, the only incentives offered in this context were automotive- or travel-related incentives. The present invention offers a new way to improve competition within the automotive industry (or other industries) by enabling the supplier to offer the beauty products and/or visual display free of charge, as part of the deal. The retail store or venue has no out-of-pocket cost to employ the beauty products display because his wholesale suppliers would likely offer the display set-up for free in order to compete for the supply contract. This partnership can be very advantageous and profitable for everyone involved along this supply chain. Using lubricant oil as an example, the oil supplier continues its relationship with the retail shop, the lubricant oil distributor gladly keeps his supply contract with the shop, the store has a new way to attract customers and increase revenue without added and out of pocket cost, and the male consumer has easy access to quality name brand beauty product and educational materials during the time when he has little to do but wait for an oil change on his car.

Similarly, the beauty product supplier may supply the visual display free of charge to the male-frequented venue and may even agree to pay the venue to maintain the visual display, or may share profits from the beauty product sales with the venue.

In one embodiment, the method includes providing visual displays at more than one male-frequented venue. For example, a chain of oil change stations could provide a display in the waiting area at each of its stores, so that customers will be able to expect to see the beauty product display at each oil change station, and the customers can go to the oil change station specifically for the beauty products even when they do not need any automotive service. Each store can have one visual display, or a single store can have two or more visual displays in the store. A chain of home improvement or sporting goods stores could do the same.

In another embodiment, a method for marketing beauty products to male customers includes cross-promoting the beauty products with non-beauty products, such as for example an automotive product or service. In one embodiment the cross-promoting includes providing coupons or discounts for the automotive product based on purchase of the beauty product, or vice versa. In another embodiment, the cross-promoting includes promoting both beauty and non-beauty products and services through group-based social e-commerce services such as those offered by Groupon® (a registered trademark of Groupon Inc., Chicago, Ill.). Group based social e-commerce buying services offer substantial incentives either on products and service that consumers commonly use to get them to try a new vendor, or offer substantial discounts on an interesting opportunity to get consumers to try something new. For consumers committed to the group deal, the automotive service or product is redeemable at a local automotive venue where such products are traditionally sold or services performed. Consumers who would like to see the actual male beauty product before committing to the deal can visit the automotive venue featured to examine samples of the male beauty product. These cross-promotions and discounts draw new customers to the automotive store, thereby increasing store traffic and further encouraging the owner of the automotive store to advertise and stock the beauty products, with little or no up-front cost to the business owner.

In one embodiment, a male beauty product as described above is cross promoted with popular automotive maintenance products and services. For example, the male beauty product could be offered at a substantial discount along with a free oil change or other specific product or service redeemable at a local automotive venue, or along with a coupon or discount on an unspecified product or service at a local automotive venue. Automotive products and services cross-promoted with male beauty products through interne-based or other campaigns can be redeemed through traditional automotive retail and service facilities, or through mobile locations that serve essentially the same functions, i.e. ‘automotive facilities on wheels’.

In one embodiment, the automotive services that are promoted with the beauty product have similar characteristics and functions to the beauty product in that they relate to preventative maintenance and repairs, e.g. oil change, cooling system flush, transmission fluid flush, fuel system service, tires, brakes, filters, batteries, shock/struts, belts and general car repairs. In another embodiment, a higher cost automotive maintenance service, such as a transmission fluid service could be offered for free with the purchase of the male beauty product at full price, where combined with the value of the free automotive service, the shopper purchases both the male beauty product and the automotive service at a substantial discount. Similar cross promotions could be done with other automotive maintenance services, e.g. cooling system flush, three-step fuel-system or engine service, or with consumable automotive products, such as replacement wiper blade sets, air and cabin filters, brakes, batteries or tires. In one embodiment, the male beauty product that is cross-promoted with the automotive product or service embodies one or more characteristics of the automotive product or service, as described in more detail above.

In a further embodiment, a system and method for marketing beauty products includes providing a website that matches the configuration of the beauty products and their visual display at the male-frequented venue. For example, where the venue is an automotive venue, a website for the beauty products is provided and is configured to resemble an automotive website. For example, the website may include automotive imagery, automotive language (such as “New 2010 Models”, “Best in Class”, “year-end clearance to make room for new models”, “dealerships”, “starting at” and “MSRP” prices, “Summer Sales Event”, “0% risk for qualified buyers on all 2010 models”, etc.), and formatting similar to automotive websites (menus, thumb-nail photographs, lists of optional, standard, and “fully loaded” or luxury features, dealer contact information). The beauty products themselves can be referred to by year as the “2009 Model”, “2010 Model,” etc. The website thus reinforces the automotive theme for the beauty products. The visual display and/or the product identifiers located at the automotive venue (or other male-frequented venue) may refer the customer to this website for more information about the products.

In another embodiment of the invention, a method of marketing beauty products to male customers includes providing video advertisements or commercials with an automotive theme, including characteristics from commercials for new cars, dealerships, and automotive services. For example, a video advertisement can include automotive imagery and shots of car interiors and exteriors, and videos on the road or track. As another example, a video advertisement can include photographs or videos of an automotive repair or quick lube bay, with cars and technicians in uniform. The commercial can analogize the need for scheduled car maintenance on with the need for regular skin maintenance. The same automotive tag lines, logos, slogans, instructions, and terminology described above with regard to the visual display and beauty products can be included in the video commercial, and on the automotive-themed website. These various elements of the marketing system provide a cohesive automotive theme for the entire beauty product line.

Many varieties of male-frequented venues can employ this marketing method. These venues can be roughly categorized in three tiers. The first tier includes automotive service shops and stations, such as (A) automotive quick oil change businesses (Jiffy Lube, Pennzoil, Valvoline Instant Oil Change); (B) automotive vehicle sales and service facilities such as car dealerships having both retail and service capacity (Ford, Toyota, Chrysler, BMW, Cadillac, Audi), motorcycle dealerships (Harley Davidson, BMW Motorcycle, Kawasaki), truck dealerships (GMC, Ford, Toyota Truck), and used and new car dealers; (C) automotive repair and maintenance shops (Aamco, Meineke Car Care, Midas, Pep Boys, Goodyear Tires, Sears Auto Center); (D) automotive fueling stations with or without a separate service bay (Shell, Chevron, Texaco, Unocal 76); (E) automotive detail stations, such as car washes (Super Wash); and (F) smog test stations (ARCO Smog Pro). These are just a few examples of automotive service shops, and this list is meant to be exemplary only and not limiting in any way. Many of these service shops have a dedicated waiting area for customers to use while they are waiting for the service on their cars. Customers waiting at these types of stores are essentially a captive audience, in that they cannot easily leave the service shop until the service is completed and they have nothing to do while waiting except browse the waiting area.

Another group of male-frequented venues can be categorized as a second tier. This tier includes automotive parts and supply stores (AutoZone, Kragen Auto Parts, Pep Boys retail stores, NAPA, CarQuest, Al & Ed's Autosound). Customers at these stores are not captive audiences, as they are not waiting for service to be done on their vehicles and can leave at any time. However, as they browse the store, they may take the time to look at a beauty products display if it catches their attention.

Finally, a third tier of male-frequented venues includes non-automotive venues that are male frequented, such as (A) home repair and improvement stores (Home Depot, Lowe's, Ace

Hardware); (B) electronics stores (Circuit City, Best Buy, Fry's, Radio Shack); and (C) sporting goods stores (Big Five, Chick's, Sports Chalet, Sports Authority) and sporting arenas.

As there are over 100,000 (one hundred thousand) automotive oil change and repair stores alone (including, just as a few examples, Pep Boys, Midas Auto Centers, Goodyear Tire Centers, and Sears Auto service centers), not including automotive parts and supply stores (including, just as a few examples, NAPA, CarQuest, AutoZone, Kragen Auto Parts), in addition to electronics, home improvement, and other male-frequented venues in the United States (including, just as a few examples, Radio Shack, Best Buy, Circuit City, Fry's, Lowe's, and many others), these kiosks can reach a very wide customer base. In comparison, the number of upscale department stores with dedicated shelf space for male beauty products is relatively small (for example, 39 Neiman Marcus stores, 157 Nordstrom stores, 330 Dillard's stores, and 800 Macy's stores in the United States).

If the venue does have a dedicated waiting area (for example, car washes, repair shops, oil change stations, and dealerships), then the display can be located in this waiting area. The venue then gets the added benefit of improving the waiting area and making it more likely that customers will stay there while they wait. This can be very beneficial for automotive repair centers that have a limited number of service bays. These repair centers would prefer for the customer to wait for the vehicle, rather than coming back later, so that the vehicle does not occupy valuable shop space. With an improved waiting area, the customers are ready to pick up the car as soon as it is ready, which enables the store to move on to the next waiting car more quickly.

If the venue does not have a clearly defined waiting area (for example, gasoline stations, auto parts stores, electronics stores, home improvement stores), the display can be placed at any convenient space at the venue, such as near other products or shelves. When the venue is a gas station, the display can be located next to the gas station pumps or in the gas station's mini-mart, or the display can be integrated into the gas station pump, using video displays at the pump (for example, many Shell gas stations utilize pumps with integrated video displays), with the beauty products located nearby or in the mini-mart.

In one embodiment of the present method, a customer enters a store for automotive service. Depending on the service needed, the customer may wait in a designated waiting area or leave the vehicle at the store and come back later. Usually for maintenance services, the customer will wait. For repair services, the customer may decide to leave the vehicle if the repair is more time consuming or if the facility is very busy. The customer initially visits the service facility with a particular service in mind (i.e. oil change, brakes, or tires) and leaves once the service is done. In one embodiment, the interaction between the customer and the store proceeds as follows:

1. Customer enters a service facility or quick lube with a vehicle that needs service.

2. Customer is greeted by a service writer, sales clerk, customer service representative, or other employee.

3. Customer talks to the service writer about the desired service for the vehicle.

4. Service writer writes up a Service Ticket for the vehicle.

5. Customer goes to the designated customer waiting area to wait until the service is completed.

6. Customer surveys the waiting area and finds a seat.

7. Customer looks around and notices a television, soda/coffee/candy machines, magazines, newspapers, service brochures, wall posters, etc.

8. Customer waits and passes time with the conveniences offered by the facility or something brought from home.

9. Customer sees the beauty product display in the waiting area and approaches the display.

10. Customer reads beauty product brochures, watches beauty product video, and/or looks at beauty product package.

11. Customer has the option to call a telephone hotline with questions or go to the product website to find more information.

12. Customer is satisfied with the information given, sees that the beauty product price is clearly marked, and decides to buy.

13. Customer either takes a beauty product from the display or takes a pick-up ticket to the cashier counter.

14. Cashier either rings up the beauty product or takes pick-up ticket to exchange for a sealed beauty product.

15. Customer either pays for the beauty product first, or waits until the vehicle is ready to pay together.

16. Customer's vehicle is ready.

17. Customer's name is called.

18. Customer goes to the cashier to pay for the vehicle service and the beauty product if not previously paid in Step 15.

19. Customer receives an itemized receipt.

20. Customer receives the key to vehicle.

21. Customer leaves the service facility with the vehicle and beauty product purchase.

In another embodiment, the customer may go to the store primarily to purchase a beauty product, rather than to purchase parts or services for an automobile. The interaction between the customer and the store could proceed as follows:

1. Customer enters a service facility or quick lube.

2. Customer goes direct to the designated customer waiting area.

3. Customer sees the beauty product display in the waiting area.

4. Customer reads beauty product brochures, watches beauty product video, and/or looks at beauty product package.

5. Customer has the option to call a telephone hotline with questions or go to the product website to find more information.

6. Customer is satisfied with the information given, sees that the beauty product price is clearly marked, and decides to buy.

7. Customer either takes a beauty product from the display or takes a pick-up ticket to the cashier counter.

8. Cashier either rings up the beauty product or takes pick-up ticket to exchange for a sealed beauty product.

9. Customer pays for the beauty product.

10. Customer receives an itemized receipt.

11. Customer leaves the service facility with the beauty product purchase.

In one embodiment, a customer enters a vehicle dealership for automotive service that may or may not be under warranty or be part of the extended service package. Depending on the service needed, the customer may wait in a designated waiting area or leave the vehicle at the dealership and come back later. For maintenance services, the customer will often wait. For repair services, the customer may decide to leave the vehicle if the repair is more time consuming or if the facility is very busy. In the case where a customer waits, the customer initially visits the service facility with a particular service in mind (i.e. oil change or warranty repairs) and leaves once the service is done. In one embodiment, the interaction between the customer and the dealership proceeds as follows:

1. Customer enters a car dealership service facility with a vehicle that needs service.

2. Customer is greeted by a service writer, sales clerk, customer service representative, or other employee.

3. Customer talks to the service writer about the desired service for the vehicle.

4. Service writer writes up a Service Ticket for the vehicle.

5. Customer goes to the designated customer waiting area to wait until the service is completed.

6. Customer surveys the waiting area and finds a seat.

7. Customer looks around and notices a television, soda/coffee/candy machines, magazines, newspapers, service brochures, wall posters, etc.

8. Customer waits and passes time with the conveniences offered by the facility or something brought from home.

9. Customer decides to stretch his legs with a walk over to the adjacent vehicle showroom and browse vehicles on display. This option is available at car dealerships that have both service areas for repairs and maintenance as well as retail showrooms for sales of new or used cars. A customer waiting in the service area can wander over to the retail area to browse.

10. Customer is approached by a vehicle salesperson and has the option to test drive a vehicle or to continue browsing.

11. Customer sees an area where travel and vehicle make/model specific related items and gear are displayed. Customer approaches the area to browse.

12. Customer sees the beauty product display in the vicinity or in a customer waiting area and notices the automotive theme of the visual display and the beauty products. Customer approaches the display.

13. Customer reads beauty product brochures, watches beauty product video, and/or looks at beauty product package.

14. Customer has the option to call a telephone hotline with questions or go to the product website (if a computer is made available) to find more information.

15. Customer finds the information about the beauty products easy to understand based in part on the familiar automotive references and analogies. Customer is satisfied with the information given, sees that the beauty product price is clearly marked, and decides to buy.

16. Customer either takes a beauty product from the display or takes a pick-up ticket to the cashier counter.

17. Cashier either rings up the beauty product or takes pick-up ticket to exchange for a sealed beauty product.

18. Customer either pays for the beauty product first, or waits until the vehicle is ready to pay together.

19. Customer's vehicle is ready.

20. Customer's name is called.

21. Customer goes to the cashier to pay for the vehicle service and the beauty product if not previously paid in Step 18.

22. Customer receives an itemized receipt.

23. Customer receives the key to vehicle.

24. Customer leaves the service facility with the vehicle and beauty product purchase.

In another embodiment, the customer may go to an automotive dealership primarily to purchase a vehicle, rather than to purchase parts or services for an automobile. The interaction between the customer and the dealership could proceed as follows:

1. Customer enters a vehicle dealership.

2. Customer is greeted by a vehicle salesperson.

3. Customer describes the type of vehicle he is interested in test driving and considering buying.

4. Customer is shown the various options available at the dealership and offered test drives.

5. Customer makes an offer on a vehicle and negotiates with the salesperson or dealership manager.

6. Customer comes to an agreement with the salesperson on the purchase of the vehicle.

7. Customer told to wait in an office or showroom waiting area while his credit report is being run and paperwork being drawn up for the transaction.

8. Customer is offered coffee, soda, or water, snacks and magazines, television or a visit to the retail area where vehicle make/model specific gear is for sale to help pass time.

9. Customer sees an area where travel and vehicle make/model specific related items and gear are displayed. Customer approaches the area to browse.

10. Customer sees the beauty product display in the vicinity and approaches the display.

11. Customer reads beauty product brochures, watches beauty product video, and/or looks at beauty product package.

12. Customer has the option to call a telephone hotline with questions or go to the product website to find more information.

13. Customer is satisfied with the information given, sees that the beauty product price is clearly marked, and decides to buy.

14. Customer either takes a beauty product from the display or takes a pick-up ticket to the cashier counter.

15. Cashier either rings up the beauty product or takes pick-up ticket to exchange for a sealed beauty product.

16. Customer pays for the beauty product and receives a receipt.

17. Customer's paperwork is ready for signature.

18. Customer's name is called.

19. Customer concludes the vehicle purchase transaction with the dealership.

20. Customer's vehicle is ready for pick-up. Salesperson accompanies customer to vehicle and goes over basic features of the vehicle.

21. Customer leaves the dealership with the vehicle and beauty product purchase.

In another embodiment, the customer may go to an automotive dealership primarily to purchase a beauty product, rather than to purchase parts or services for an automobile. The interaction between the customer and the dealership could proceed as follows:

1. Customer enters a vehicle dealership.

2. Customer goes direct to the waiting area or area where vehicle make/model specific gear and travel related items are sold.

3. Customer sees the beauty product display in the waiting area.

4. Customer reads beauty product brochures, watches beauty product video, and/or looks at beauty product package.

5. Customer has the option to call a telephone hotline with questions or go to the product website to find more information.

6. Customer is satisfied with the information given, sees that the beauty product price is clearly marked, and decides to buy.

7. Customer either takes a beauty product from the display or takes a pick-up ticket to the cashier counter.

8. Cashier either rings up the beauty product or takes pick-up ticket to exchange for a sealed beauty product.

9. Customer pays for the beauty product.

10. Customer receives an itemized receipt.

11. Customer leaves the dealership with the beauty product purchase.

In another embodiment, a customer may go to an automotive parts store primarily to purchase a part or maintenance related items. The interaction between the customer and the automotive parts store could proceed as follows:

1. Customer enters a vehicle parts and supply store.

2. Customer either goes directly to the counter to ask for a part stored out of public reach behind the counter, or finds the item openly displayed in the store.

3. Customer browses the store.

4. Customer sees the beauty product display and approaches the display.

5. Customer reads beauty product brochures, watches beauty product video, and/or looks at beauty product package.

6. Customer has the option to call a telephone hotline with questions or go to the product website to find more information.

7. Customer is satisfied with the information given, sees that the beauty product price is clearly marked, and decides to buy.

8. Customer either takes a beauty product from the display or takes a pick-up ticket to the counter.

9. Cashier either rings up the beauty product or takes pick-up ticket to exchange for a sealed beauty product.

10. Customer pays for the beauty product and any other parts and supply purchases and receives a receipt.

11. Customer leaves the store with the vehicle parts and beauty product purchase.

In another embodiment, a customer may go to a male-frequented venue that is not an automotive store, but is instead some other type of venue that male customers visit, such as electronic stores, sporting goods stores, and home improvement stores. The interaction between the customer and the venue could proceed as follows:

1. Customer enters the electronics, home improvement, sporting goods store, or other male-frequented venue.

2. Customer browses.

3. Customer sees the beauty product display, notices the electronics/home improvement/sports or other theme on the display, and approaches the display.

4. Customer reads beauty product brochures, watches beauty product video, and/or looks at beauty product package.

5. Customer has the option to call a telephone hotline with, questions or go to the product website to find more information.

6. Customer is satisfied with the information given, sees that the beauty product price is clearly marked, and decides to buy.

7. Customer either takes a beauty product from the display or takes a pick-up ticket to the counter.

8. Cashier either rings up the beauty product or takes pick-up ticket to exchange for a sealed beauty product.

9. Customer pays for the beauty product and any other items and receives an itemized receipt.

10. Customer leaves the venue with the other items and beauty product purchase

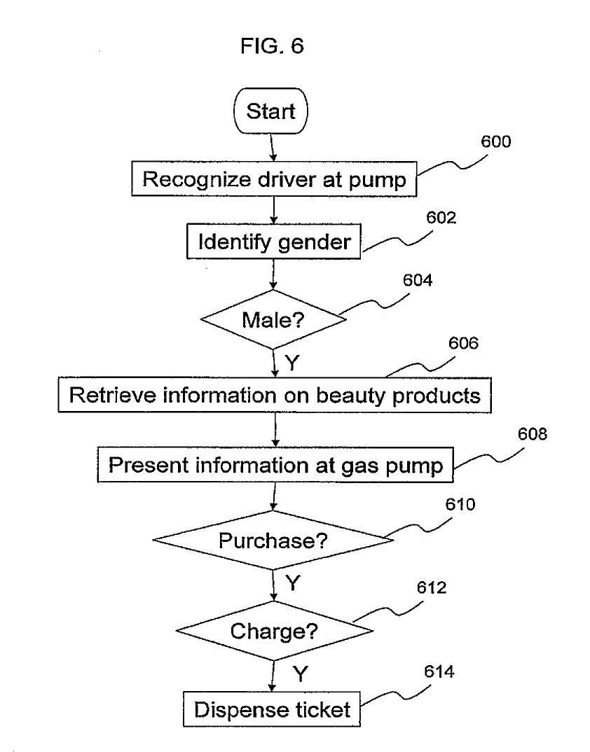

FIG. 6 is a flow diagram of a process for marketing beauty products according to one embodiment of the invention. According to this embodiment, the male-frequented establishment is a gas station, and the display device is a display at a gas pump. The process starts in step 600, with the gas pump recognizing that a driver has pulled up to the pump. This may be done, for example, by detecting that the driver has entered a credit card or begun fueling.

In step 602, the gender of the person fueling the gas is identified. For example, the gas pump may include software that prompts the user to enter this information manually, or that automatically detects the gender based on information encoded in the credit card provided by the user. The credit card information may be provided by entering the card manually or by a wireless radio frequency device (such as a gas card wand). If the gender is identified as being male, in step 604, the software accesses a data storage device and retrieves, in step 606, information on one or more beauty products targeted to males. The retrieved information may be a video of the product or any other visual and/or audio presentation containing information on the product. The presentation may be interactive, allowing the user to select specific sections of the presentation, or allowing the user to request further information. A keypad or touch screen monitor on the gas pump can allow this interaction.

In step 608, the retrieved information is presented at the gas pump, such as, for example, at the video display at the gas pump. In step 610, the software determines whether the user has indicated a desire to purchase the product. For example, the user could enter yes or no in response to a prompt, or could touch a keypad or touch screen to select a particular product. If the answer is yes, the purchase price is charged to a credit card in step 612, such as, for example, the credit card already provided by the user to fuel the gas, and a ticket is dispensed in step 614 with the product's identification. If no credit card was provided or if the user does not want to charge the credit card, the ticket is simply dispensed by the gas pump. The user can take the ticket to the cashier to pick up the product and pay for it if not already done at the pump. While the method above has been described in relation to beauty products, other types of products can be marketed with this method as well. For example, health foods, self-help educational materials, gifts, and other items can be advertised on a visual display at the male-frequented venue.

As described above, the embodiments of the present invention provide a novel method for marketing beauty products to male customers at male-frequented locations. The method provides a cost-effective, economical, convenient, comfortable, reliable and private way to advertise and provide easy access to beauty products directly to target consumers without the disadvantages related to marketing through traditional advertising and retail channels.

1-31. (canceled)

32. A system for delivering beauty products to male customers, comprising:
a beauty product for a male customer;
a male-frequented venue conducting a primary line of business that is unrelated to the beauty product;
a visual display at the male-frequented venue being configured to provide information about the beauty product; and
a product identifier dispenser at the male-frequented venue configured to dispense a product identifier that identifies the beauty product,
wherein the beauty product has a characteristic of an automotive theme.

33. The system of claim 32, wherein the male-frequented venue is an automotive venue for providing an automotive product or service to the male customers.

34. The system of claim 32, wherein the male-frequented venue is an automotive venue, and wherein the beauty product has a motor oil bottle shape.

35. The system of claim 32, wherein the visual display comprises the characteristic of the automotive theme.

36. The system of claim 32, further comprising a webpage incorporating the automotive characteristic that is configured to display information about the beauty product.

37. The system of claim 32, wherein the characteristic of the beauty product comprises a distinctive product shape.

38. The system of claim 37, wherein the distinctive product shape comprises a motor oil bottle shape.

39. The system of claim 32, wherein the characteristic of the beauty product comprises an instruction.

40. The system of claim 39, wherein the instruction comprises a three-step maintenance routine for a vehicle, and wherein the beauty product is configured to convey the three-step maintenance routine for the beauty product to the male customers.

41. The system of claim 32, wherein the characteristic of the beauty product comprises an automotive graphic.

42. The system of claim 32, wherein the beauty product is at the male-frequented venue.

43. The system of claim 42, wherein the visual display comprises a display case, and wherein the beauty product is in the display case.

44. The system of claim 43, wherein the male-frequented venue comprises an automotive business, and wherein the beauty product has a motor oil bottle shape, and wherein the visual display comprises an automotive graphic.

45. A system for selling beauty products to male customers, comprising:
an automotive venue providing an automotive service or product;
a beauty product configured to embody a characteristic of the automotive service or product; and
a visual display at the automotive venue including an automotive graphic configured to provide information about the beauty product.

46. The system of claim 45, wherein the visual display comprises a display case and wherein the beauty product is in the display case.

47. The system of claim 46, wherein the automotive venue provides an automotive product, and wherein the characteristic of the automotive service or product comprises a shape of the automotive product.

48. The system of claim 47, wherein the shape comprises a motor oil bottle shape.

49. The system of claim 45, wherein the automotive venue provides an automotive service having at least two steps, and wherein the beauty product is configured to incorporate the at least two steps.

50. The system of claim 45, wherein the characteristic comprises one of an automotive graphic, an automotive theme, an automotive silhouette, an automotive packaging, an automotive instruction, or an automotive shape.

51. A method for utilizing a display apparatus, comprising:
providing an automotive product or service at a male-frequented venue that has a primary automotive business unrelated to beauty products;
providing the display apparatus that displays information about the beauty products targeted to male customers at the male-frequented venue; and
providing the beauty products, which have a characteristic of the automotive product or service, at the male-frequented venue.

52. The method of claim 51, wherein the beauty product has an automotive-themed graphic, label, or instruction on its outer surface.

53. The method of claim 51, wherein the information about the beauty products is related to the automotive produce or service at the male-frequented venue.

54. The method of claim 51, further comprising providing a webpage having an automotive theme, the webpage configured to display information about the beauty product.

55. A method for utilizing a visual display, comprising:
providing an automotive product or service at a male-frequented venue that has a primary automotive business unrelated to beauty products;
providing a webpage for displaying information about a beauty product targeted to male customers and having an automotive characteristic;
providing a visual display for displaying information about the beauty product, the visual display providing an address for the webpage for the beauty product; and
placing the visual display at the male-frequented venue.

56. The method of claim 55, further comprising configuring the beauty products to embody the automotive characteristic.

57. The method of claim 56, further comprising displaying purchasing information for the beauty products at the webpage.

58. The method of claim 57, further comprising displaying purchasing information for the beauty products at the male-frequented venue.

59. A packaging container for a grooming product targeted to male customers, comprising:
a box portion having a front panel and a back panel;
a grooming product located in the box portion; and
a window in the front panel of the box portion for viewing the beauty product, the packaging container being configured to resemble a bottle of motor oil, to associate the grooming product with automobiles.

60. The packaging container of claim 59, wherein the back panel comprises an upper portion comprising an angled edge and a bottle cap or representation thereof,
